(19) United States
(12) Patent Application Publication
(10) Pub. No.: US 2008/0304887 A1
(43) Pub. Date: Dec. 11, 2008

(54) CURL CORRECTING DEVICE, IMAGE FORMING APPARATUS, AND SHEET FINISHER

(75) Inventor: Takayuki Horie, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/041,938

(22) Filed: Mar. 4, 2008

(30) Foreign Application Priority Data
Jun. 6, 2007 (JP) 2007-150231

(51) Int. Cl. G03G 15/00

(52) U.S. Cl. 399/406

(57) ABSTRACT

Disclosed is a curl correcting device comprising: a first nip forming member conveying a sheet by rotation; and a second nip forming member having pressing members, wherein at least one of the pressing members is opposed to the first nip forming member in a standstill state at a time of curl correcting, presses the first nip forming member to press the sheet, and is capable of being switched between the pressing members.

### BACKGROUND OF THE INVENTION

1. Field of the Invention

The present invention relates to a curl correcting technique for fairing a curved sheet.

2. Related Art

In a copier, a printer, a facsimile, a sheet finisher, or the like, a sheet sometimes curls, and the curl of a sheet produces disadvantages such as bad conveyance, a trouble in sheet finishing, and an irregularity of ejected sheets.

Curl correcting techniques were developed accordingly.

The curls of sheets are not uniform, but various.

Such various sheet curls are representatively caused by the unevenness of paper thicknesses.

In an electrophotographic printing system image forming apparatus, the heat fixing of a toner image is performed. If a sheet that has passed through a fixing apparatus and has been processed by being heated is thin, then the sheet has a tendency to curl so that the toner image carrying surface thereof is convex. If a sheet that has passed through the fixing apparatus and has been processed by being heated is thick, then the sheet reversely has a tendency to curl so that the toner image carrying surface is concave.

Consequently, only the function of correcting curls in one direction is not sufficient for an electrophotographic printing system image forming apparatus, and a curl correcting device capable of selectively performing bidirectional curls is needed.

Japanese Patent Application Laid-Open Publications Nos. Hei 8-165049 and 2005-41614 proposed such curl correcting device.

Japanese Patent Application Laid-Open Publication No. Hei 8-165049 arranges a couple of belts to be opposed to each other and displaces a switching roller arranged between a couple of supporting rollers, and thereby switches the curl correcting function thereof.

Japanese Patent Application Laid-Open Publication No. 2005-41614 adopts the configuration of arranging two small diameter rollers to be opposed to a large diameter roller to selectively contact a small diameter roller to the large diameter roller. Japanese Patent Application Laid-Open Publication No. 2005-41614 then sets the hardness of the large diameter roller to an intermediate value between the hardness of the small diameter rollers different from each other, and thereby inverts the deformations of the rollers between the cases of the contact of a small diameter roller on one side and the contact of the other small diameter roller to switch the direction of curl correcting.

A curl correcting device is installed in the paper ejecting section of an image forming apparatus or the sheet introducing section of a sheet finisher, and consequently the curl correcting device is required to be small in size. The curl correcting device disclosed in Japanese Patent Application Laid-Open Publications Nos. Hei 8-165049 and 2005-41614 each have a large occupation space, and consequently have a problem of the enlargement of the size of the image forming apparatus or the sheet finisher.

Moreover, the curl correcting device each have the problems of the complexity of their structures and the lowering of the smoothness of the conveyance of sheets.

The inventions disclosed in Japanese Patent Application Laid-Open Publications Nos. Hei 8-165049 and 2005-41614 enables the correcting of inverted direction curls. However, the curls that must be corrected include the curls having different degrees of curvature besides the curls having different directions, and an apparatus capable of performing proper correcting to variously curved sheets has been desired.

However, the aforesaid related art makes the apparatus be further complicated and larges in size in order to satisfy the needs mentioned above.

### SUMMARY

It is one of objects of the present invention to solve the aforesaid problems of the related art curl correcting device and to provide a small-sized curl correcting device capable of proper curl correcting with a simple structure, and an image forming apparatus and a sheet finisher, each provided with the curl correcting device like that.

According to an aspect of the present invention, there is provided a curl correcting device comprising: a first nip forming member conveying a sheet by rotation; and a second nip forming member having pressing members, wherein at least one of the pressing members is opposed to the first nip forming member in a standstill state at a time of curl correcting, presses the first nip forming member to press the sheet, and is capable of being switched between the pressing members.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a view showing the whole image forming system provided with a curl correcting device of an embodiment of the present invention;

FIG. 2 is a view showing a curl correcting device of a first embodiment of the present invention;

FIG. 3A is another view showing the curl correcting device of the first embodiment of the present invention;

FIG. 3B is a further view showing the curl correcting device of the first embodiment of the present invention;

FIG. 4 is a block diagram of the control system of the curl correcting device;

FIG. 5 is a view showing a curl correcting device ofo a second embodiment of the present invention;

FIG. 6 is a view showing a curl correcting device of a third embodiment of the present invention; and

FIG. 7 is a view for illustrating a curl of a sheet.

### DETAILED DESCRIPTION OF THE PREFERRED EMBODIMENTS

In the following, the curl correcting device of the present invention will be described by means of the preferred embodiments with reference to the attached drawings.

### <Image Forming Apparatus>

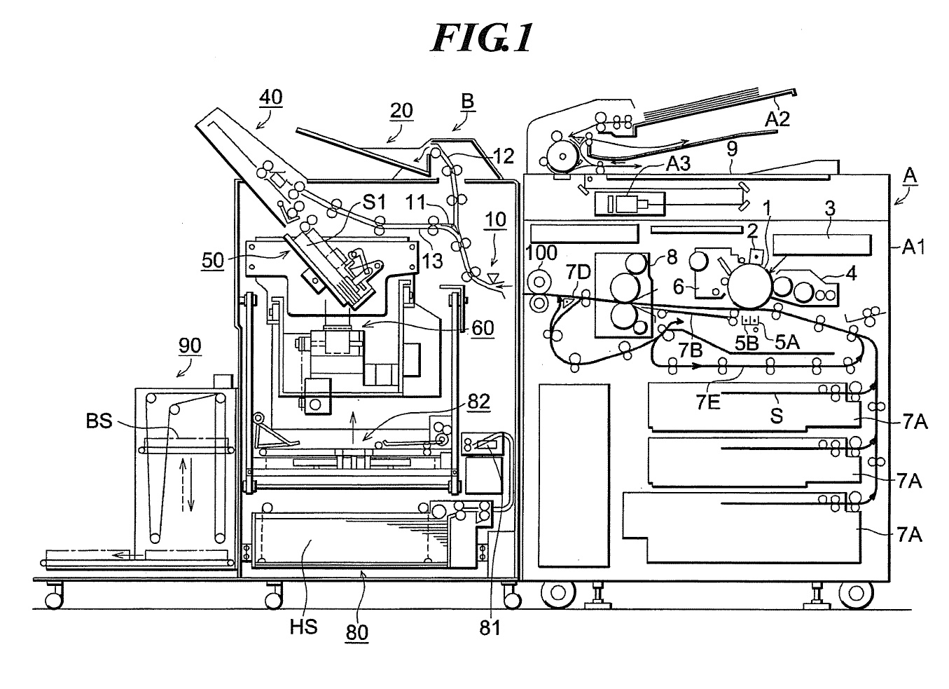

FIG. 1 is a view showing the whole image forming system provided with a curl correcting device of an embodiment of the present invention.

The image forming system includes an image forming apparatus A and a sheet finisher B.

The image forming apparatus A forms an image on a sheet by an electrophotographic printing system, and is composed of an image forming section A1, an original conveying apparatus A2, and an image reading section A3.

In the image forming section A1, a charging apparatus 2, an exposing apparatus 3, a developing apparatus 4, a transferring apparatus 5A, a separating apparatus 5B, and a cleaning apparatus 6 are arranged around a drum-shaped photosensitive body 1. Charging, exposing, developing, and transferring are performed by these electrophotographic process apparatus, and a toner image is formed on the photosensitive body 1. An image is then formed on a sheet S.

The sheets S are housed in three paper feeding trays 7A, and the sheets S are fed from these paper feeding trays 7A one by one. Then, a toner image on the photosensitive body 1 is transferred to the sheet S by the transferring apparatus 5A.

The toner image transferred to the sheet S passes through a fixing apparatus 8 to be processed by the fixing processing thereof. The sheet S processed by the fixing processing is ejected from a curl correcting device 100, or is conveyed to a paper re-feeding path 7E.

A switching gate 7D switches and guides the sheet S in face-down paper ejection in one-side printing, in face-up paper ejection in one-side printing, or in front surface image formation in both side image formation. That is, the switching gate 7D allows the sheet S to go straight on in the face-up paper ejection, and the switching gate 7D guides the sheet S downward in the face-down paper ejection and the both side image formation.

After the sheet S has been guided downward in the face-down paper ejection, the sheet S switchbacks to be conveyed upward, and is ejected from the curl correcting device 100.

After the sheet S has been guided downward and turned over by a switchback in the both side image formation, the sheet S passes through the paper re-feeding path 7E to be re-fed to a transferring section, in which the transferring apparatus 5A is disposed, and the transferring of a back side image is performed.

The original conveying apparatus A2 conveys originals to a reading position one by one. The image reading section A3 reads the image of an original conveyed by the original conveying apparatus A2 or the image of an original placed on an original stand 9, and generates an image signal.

The sheet finisher B is an apparatus of bundling a plurality of pamphlet constituting sheets sent from the image forming apparatus A to constitute a sheaf of pamphlet constituting sheets, and of joining a cover sheet to the sheaf to form the pamphlet.

The sheet finisher B includes a conveying section 10 conveying a sheet S ejected from the image forming apparatus A to an ejected paper tray 20 or a sheet inverting section 40, the ejected paper tray 20, the sheet inverting section 40, an accumulating section 50 accumulating the sheets S sent therein one by one or several by several, applying means 60, a cover housing section 80 housing covers HS, a cover supporting section 82 supporting a cover, and a pamphlet ejecting section 90.

The travelling direction of the sheet S ejected from the image forming apparatus A is switched by a switching gate 11 provided in the conveying section 10. Then, the sheet S is ejected to the ejected paper tray 20 after passing through an ejecting path 12. Alternatively, the sheet S is conveyed to the sheet inverting section 40. The sheet S is ejected to the ejected paper tray 20 in the case of not a bookbinding mode.

In the bookbinding mode, the sheet S is conveyed to the sheet inverting section 40 after passing through a conveying path 13. Then, after the sheet S has switchbacked in the sheet inverting section 40, the sheet S is conveyed to the accumulating section 50. The accumulating section 50 rotates at the stage at which the number of the sheets S accumulated therein reaches a number of sheets for constituting a pamphlet, and holds the sheaf of the sheets S in almost the vertical state.

The sheet inverting section 40 accumulates the sheets S as a buffer between the image forming apparatus A and the accumulating section 50.

That is, although the sheets S is continuously ejected from the image forming apparatus A, the sheet finisher B executes a bookbinding process after accumulating the sheets S in the accumulating section 50. Consequently, the accumulating section 50 needs a predetermined length of time from the completion of the accumulation of the number of the sheets S constituting a pamphlet to the change to the enable state thereof for receiving the next sheet S.

The sheet inverting section 40 accumulates the sheets S ejected from the image forming apparatus A during this time interval.

The applying means 60 applies an adhesive to the under surface of the sheaf of the sheets S held in the vertical state by the accumulating section 50.

A cover HS touches the sheaf of the sheets S, on which the adhesive is applied, to be adhered thereto.

The pamphlet BS produced by adhering the cover HS to the sheaf of the sheets S is ejected to the pamphlet ejecting section 90.

### First Embodiment

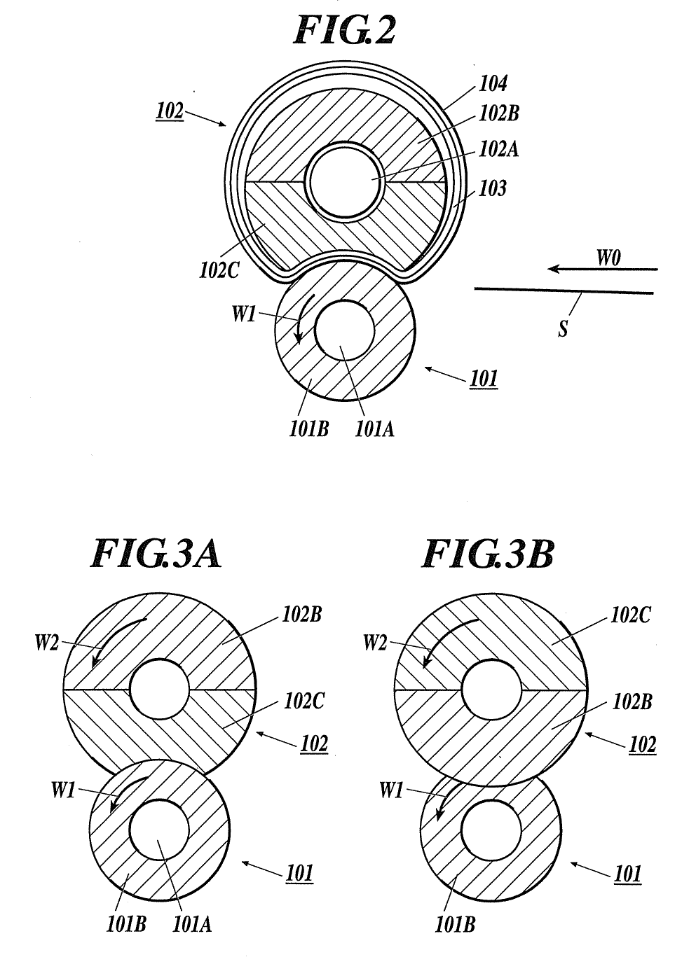

FIGS. 2, 3A, and 3B are views showing the curl correcting device 100 of a first embodiment of the present invention.

The curl correcting device 100 includes a first nip forming member 101 and a second nip forming member 102.

The first nip forming member 101 is a rotation roller composed of a shaft 101A made of a metal or the like, and an elastic member 101B formed on the shaft 101A.

The second nip forming member 102 is a cylindrical member composed of a shaft including a one-way clutch 102A, and a plurality of pressing members 102B (first pressing member) and 102C (second pressing member), both formed in the shaft. A sliding belt 103 and a driven belt 104 intervene between the first nip forming member 101 and the second nip forming member 102.

That is, the first pressing member 102B and the second pressing member 102C are selectively opposed to the first nip forming member 101 by being switched. Moreover, the sliding belt 103 and the driven belt 104 are arranged so that they cover around the second nip forming member 102 including the pressing member 102B (first pressing member), and 102C (second pressing member).

The first nip forming member 101 is a roller for conveying a sheet S and rotates into the direction indicated by an arrow W1.

The one-way clutch 102A prevents the rotation of the second nip forming member 102 by being driven by the first nip forming member 101.

The driven belt 104 revolves by being driven by the first nip forming member 101 owing to the sliding operation of the sliding belt 103.

The introduced sheet S is nipped by the first nip forming member 101 and the second nip forming member 102 to be conveyed.

The driven belt 104 slides on the second nip forming member 102 by driven by the first nip forming member 101 by the rotation of the first nip forming member 101.

The first nip forming member 101 includes the elastic member 101B, the hardness of which is M1. The elastic member 101B is made of natural rubber, synthetic rubber, such as urethane, or sponge.

The sliding belt 103 is made of a glass cloth fiber having a higher slidability by coating a fluoride resin around it. It is preferable to heighten the slidability furthermore by adding silicone or grease to it.

The driven belt 104 is made of a polyimide resin having higher slidability by coating a fluoride resin around it.

The second nip forming member 102 includes the pressing member 102B and 102C, each of which occupies a half circle.

The pressing member 102B is made of a rigid body, such as a metal, or an elastic member. The elastic member is made of natural rubber, synthetic rubber, such as urethane, or sponge, and has hardness M2.

The pressing member 102C is made of an elastic member. The elastic member is made of natural rubber, synthetic rubber, such as urethane, or sponge, and has hardness M3.

The hardness M1, M2, and M3 are in the following relations: M2>M1>M3.

As shown in FIG. 3A, because the hardness is in the relation mentioned above, the pressing member 102C deforms when the elastic member 101B touches the pressing member 102C with a pressure, and a nip convex to the upper side, that is, to the side of the pressing member 102C, is formed. As shown in FIG. 3B, when the elastic member 101B touches the pressing member 102B with a pressure, a nip convex to the lower side, that is, to the side of the elastic member 101B, is formed.

The driven belt 104 is driven by the first nip forming member 101 to move, and the sheet S is corrected when the sheet S passes between the first and second nip forming members 101 and 102 even if the sheet S curls into either direction.

The second nip forming member 102 is at a standstill when the first nip forming member 101 is rotating. When the curl correcting device 100 is changed from the state of FIG. 3A to the state of FIG. 3B, or from the state of FIG. 3B to the state of FIG. 3A, the second nip forming member 102 is rotated into the direction shown by an arrow W2. The one-way clutch 102A is a clutch allowing the rotation into the direction shown by the arrow W2, and is a mechanism for switching at the time of correcting different directional curls.

Because the different directional curls can be corrected by the rotation of the second nip forming member 102, the small-sized curl correcting device 100 having the bidirectional curl correcting function can be realized in a simple structure.

Because the present embodiment can change the degree of curl correcting by changing the distance between the first nip forming member 101 and the second nip forming member 102, the present embodiment can perform proper curl correcting to the various curved degrees of curls by changing the distance between the first and second nip forming members 101 and 102.

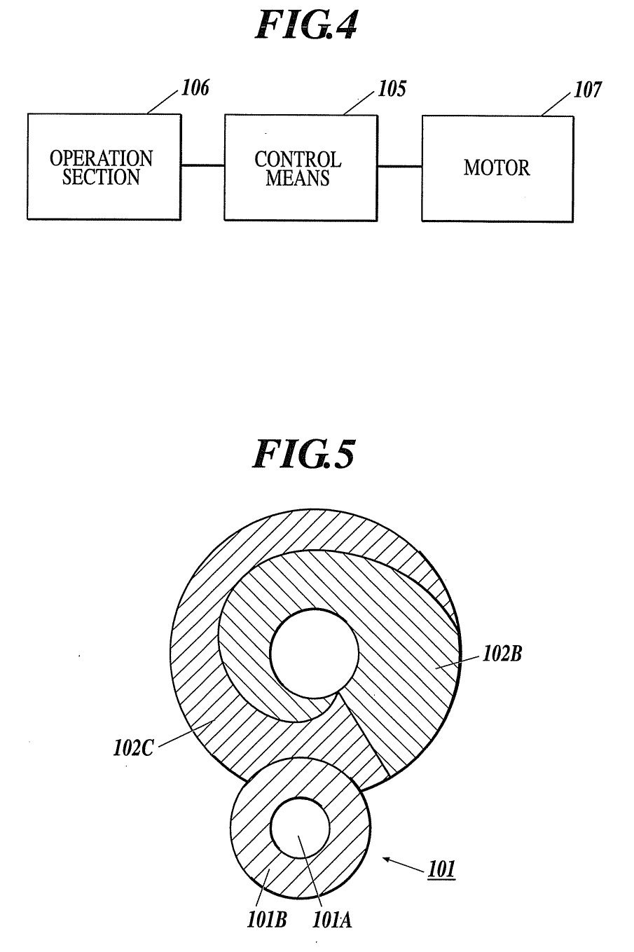

FIG. 4 is a block diagram of the control system of the curl correcting device 100.

A reference numeral 105 denotes control means; a reference numeral 106 denotes an operation section; and a reference numeral 107 denotes a motor driving the second nip forming member 102 to rotate into the direction of the arrow W2.

In the operation section 106, the type of a sheet S to be used is set by an operator. For example, the operation section 106 is configured to be able to set the type of the sheet S to each of the thicknesses (weights) of the sheets S.

After the type of the sheet S has been set, the control means 105 starts the motor 107 to set the second nip forming member 102 to a phase corresponding to the set type of the sheet S.

Incidentally, it is also possible to provide a manually setting mode for manually setting the curl correcting device 100. It is also possible to configure the curl correcting device 100 to be able to set the second nip forming member 102 according to the degree and the direction of an actually formed curl by examining the curl by test printing.

Moreover, it is also possible to provide curl detecting means for detecting a curl, and to set the second nip forming member 102 on the basis of a detection result of the curl detecting means.

### Second Embodiment

FIG. 5 shows a curl correcting device of a second embodiment of the present invention.

The first nip forming member 101 is the same one as that of the first embodiment.

The second nip forming member 102 includes pressing members 102B (first pressing member) and 102C (second pressing member). The total thickness of the pressing member 102B and the second pressing member 102C is fixed. As shown in FIG. 5, the pressing members 102B and 102C are formed on a shaft in a laminated structure.

The thicknesses of the pressing members 102B and 102C change by the change of the phase of the part of the second nip forming member 102 opposed to the first nip forming member 101, and the second nip forming member 102 is configured so that the difficulty of the deformation of the laminated body composed of the pressing members 102B and 102C changes according to the thickness.

The relations among the hardness M1 of the elastic member 101B, the hardness M2 of the pressing member 102B, and the hardness M3 of the pressing member 102C are set to be M2>M1>M3 similarly to those of the first embodiment.

The elastic member 101B of the first nip forming member 101 changes, or the second nip forming member 102 deforms, according to the set phase of the second nip forming member 102. Moreover, the degree of the deformation variously changes.

As shown in FIG. 5, because the layer thickness of the pressing member 102C having the lower hardness than that of the elastic member 101B changes according to the change of the part of the second nip forming member 102 opposed to the first nip forming member 101, it is possible to perform proper curl correcting to various curls by setting the curl correcting device so as to correspond to the various degrees and directions of curls by changing the phase of the part of the second nip forming member 102 opposed to the first nip forming member 101 according to the direction and the curved degree of the curl of a sheet.

Then, because the switching of the curl correcting function is performed by the rotation of the nip forming member 102, various curl correcting functions can be realized by the small-sized and simple mechanism.

### Third Embodiment

FIG. 6 shows a curl correcting device of a third embodiment of the present invention.

The first nip forming member 101 thereof is the same one as those of the first and the second embodiments.

The second nip forming member 102 thereof includes pressing members 1021, 1022, 1023, and 1024.

The tips of the pressing members 1021 and 1022 are formed in convexes, and the tips of the pressing members 1023 and 1024 are formed in concaves. The curvature radii of the tips of the pressing members 1021-1024 are then different from one another.

The curl correcting dealing with the differences of the directions and degrees of curls is performed by opposing any one of the pressing members 1021-1024 to the first nip forming member 101. Incidentally, the hardness of the front tips of the pressing members 1021-1024 may be different from one another, and various kinds of curl correcting are enabled by changing the forms and hardness of the tips.

Moreover, it is a matter of course that a driven belt and a sliding belt can be used also in each of the embodiments shown in FIGS. 3A, 3B, 5, and 6.

Although the curl correcting device 100 is provided in the paper ejecting section of the image forming apparatus A in FIG. 1, the curl correcting device 100 may be provided in the sheet carrying section of the sheet finisher B in place of being in the image forming apparatus A.

### EXAMPLE

The effects of curl correcting were confirmed by means of the second embodiment shown in FIG. 5.

The results of the experiments were as follows.

First Nip Forming Member 101: the elastic member 101B of an urethane rubber layer (hardness: 60°) having the thickness of 1.0 mm was formed on the surface of a metal roller

Pressing Member 102B: aluminum

Pressing Member 102C: sponge (hardness: 30°)

The pieces of the hardness were measured values with an Asker C hardness meter.

The effects of the curl correcting were examined by passing sheets having different weights.

TABLE 1

| | Paper | Paper | Paper | Paper | Paper |
|---|---|---|---|---|---|
| | Type 1 | Type 2 | Type 3 | Type 4 | Type 5 |
| Paper Weight | 57 g/M² | 80 g/M² | 100 g/M² | 200 g/M² | 300 g/M² |
| Original Curl | +16 mm | +5 mm | +2 mm | −7 mm | −10 mm |
| Quantity | | | | | |
| Thickness of | +2 mm | −6 mm | −7 mm | −11 mm | −12 mm |
| 102C = 0 mm | | | | | |
| Thickness of | +6 mm | −1 mm | −4 mm | −8 mm | −10 mm |
| 102C = 0.2 mm | | | | | |
| Thickness of | +12 mm | +4 mm | 0 mm | −7 mm | −6 mm |
| 102C = 0.5 mm | | | | | |
| Thickness of | +16 mm | +6 mm | +6 mm | +3 mm | −3 mm |
| 102C = 1.5 mm | | | | | |
| Thickness of | +20 mm | +10 mm | +9 mm | +7 mm | +2 mm |
| 102C = 3.0 mm | | | | | |

The results were as shown in Table 1.

Incidentally, the curl quantities were as follows.

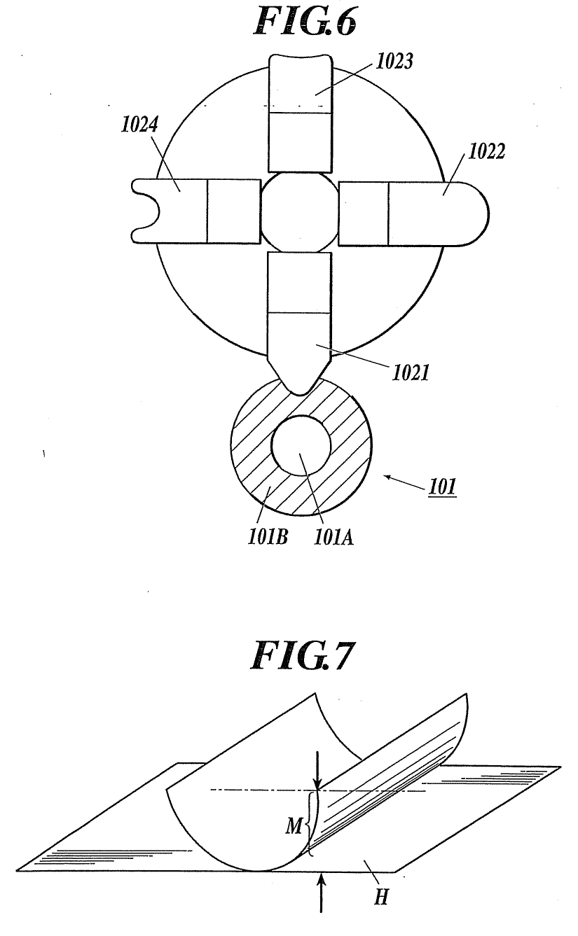

As shown in FIG. 7, a curled sheet S was placed on a plane H, and a height M of a corner that rose to the highest point among those of the four corners of the sheet S was set as the curl quantity.

Incidentally, a curl in the way in which the central part of the printed surface of the sheet was curved to be convex was set as “+”, and a curl in the way in which the central part of the printed surface was curved to be concave was set as “−”.

The used sheets had the A-4 sizes, and the sheets were conveyed with their short sides being in their conveyance directions. Thin sheets had the tendencies of curling in the way in which their printed surface sides were convex by passing through a fixing apparatus, and thick sheets had the tendencies of curling in the way in which their printed surface sides were conversely concave by passing through the fixing apparatus.

As shown in Table 1, the curls were able to be almost removed by changing the phases of the part of the second nip forming member 102 opposed to the first nip forming member 101.

According to the above mentioned example, because the direction of curl is changed by switching the pressing members opposed to the first nip forming member, a curl can be corrected by the small-sized curl correcting device 100 with a simple structure. Furthermore, it is possible for the curl correcting device to realize easily correcting the curls into both sides.

All of the disclosures of Japanese Patent Application No. 2007-150231 filed on Jun. 6, 2007 are incorporated herein by reference.

What is claimed is:

1. A curl correcting device comprising:
a first nip forming member conveying a sheet by rotation; and
a second nip forming member having pressing members,
wherein at least one of the pressing members is opposed to the first nip forming member in a standstill state at a time of curl correcting, presses the first nip forming member to press the sheet, and is capable of being switched between the pressing members.

2. The curl correcting device of claim 1, wherein the second nip forming member includes a plurality of the pressing members, and one of the plurality of pressing members is selectively opposed to the first nip forming member by being switched.

3. The curl correcting device of claim 2, wherein each of the plurality of pressing members includes a tip having different shape from one another.

4. The curl correcting device of claim 2, wherein each of the plurality of pressing members has a tip having different hardness from one another.

5. The curl correcting device of claim 2, wherein the first nip forming member includes an elastic member;
the pressing members include a first pressing member and a second pressing member; and
the elastic member, the first pressing member and the second pressing member satisfy following relation, M2>M1>M3
where M1 represents hardness of the elastic member, M2 represents hardness of the first pressing member and M3 represents hardness of the second pressing member.

6. The curl correcting device of claim 5, wherein the first and the second pressing members are made of elastic materials.

7. The curl correcting device of claim 5, wherein the first pressing member is made of a rigid body.

8. The curl correcting device of claim 1, wherein the pressing members include a layer that is deformed by the first nip forming member at a time of nipping the sheet, and a thickness of the layer changes by the pressing members being switched.

9. The curl correcting device of claim 1, further comprising a driven belt covering the second nip forming member, the driven belt driven by the first nip forming member.

10. The curl correcting device of claim 9, further comprising a sliding member provided between the second nip forming member and the driven belt.

11. The curl correcting device of claim 1, wherein the second nip forming member rotates to switch the pressing members.

12. The curl correcting device of claim 11, wherein the second nip forming member includes a one-way clutch preventing a driven rotation of the second nip forming member when the first nip forming member rotates, the one-way clutch allowing a rotation of the second nip forming member when the pressing members are switched.

13. An image forming apparatus comprising the curl correcting device of claim 1.

14. A sheet finisher comprising the curl correcting device of claim 1.
